(19) United States
(12) Patent Application Publication
(10) Pub. No.: US 2026/0163771 A1
(43) Pub. Date: Jun. 11, 2026

(54) CELL IDENTIFIER INFORMATION FROM OFFSET X-SHAPED FREQUENCY MODULATED CONTINUOUS WAVES

(71) Applicant: QUALCOMM Incorporated, San Diego, CA (US)

(72) Inventors: Kangqi LIU, San Diego, CA (US); Jing SUN, San Diego, CA (US); Weimin DUAN, San Diego, CA (US)

(21) Appl. No.: 18/970,763

(22) Filed: Dec. 5, 2024

(51) Int. Cl. H04L 27/00

(52) U.S. Cl. CPC H04L 27/0014

(57) ABSTRACT

An apparatus has one or more memories and one or more processors coupled to the one or more memories. The processor(s) is configured to obtain a first frequency modulated continuous wave (FMCW) waveform having a first center frequency. The first FMCW waveform has a first FMCW signal, and a second FMCW signal that intersects with the first FMCW signal. The processor(s) is also configured to obtain partial information of a cell identifier (ID). The obtaining is associated with a frequency offset between the first center frequency and a synchronization raster frequency. The processor(s) is further configured to perform cell detection based on the partial information of the cell ID.

### FIELD OF THE DISCLOSURE

The present disclosure relates generally to wireless communications, and more specifically to cell identifier (ID) information obtained from X-shaped frequency modulated continuous waves (X-FMCWs) that are offset in frequency from one another.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and long-term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a fifth generation (5G) Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

Aspects of the present disclosure are directed to an apparatus. The apparatus has one or more memories and one or more processors coupled to the one or more memories. The processor(s) is configured to obtain a first frequency modulated continuous wave (FMCW) waveform having a first center frequency. The first FMCW has a first FMCW signal, and a second FMCW signal that intersects with the first FMCW signal. The processor(s) is also configured to obtain partial information of a cell identifier (ID). The obtaining is associated with a frequency offset between the first center frequency and a synchronization raster frequency. The processor(s) is further configured to perform cell detection based on the partial information of the cell ID.

In other aspects of the present disclosure, a method for wireless communication at a wireless node includes obtaining a first frequency modulated continuous wave (FMCW) waveform having a first center frequency. The first FMCW waveform has a first FMCW signal, and a second FMCW signal that intersects with the first FMCW signal. The method also includes obtaining partial information of a cell identifier (ID). The obtaining is associated with a frequency offset between the first center frequency and a synchronization raster frequency. The method further includes performing cell detection based on the partial information of the cell ID.

Other aspects of the present disclosure are directed to a user equipment (UE). The UE has at least one transceiver. The UE also has one or more memories storing instructions. The UE further has one or more processors configured to execute the instructions to cause the UE to receive, via the at least one transceiver, a first frequency modulated continuous wave (FMCW) waveform having a first center frequency. The first FMCW waveform has a first FMCW signal, and a second FMCW signal that intersects with the first FMCW signal. The UE still further has one or more processors configured to receive, via the at least one transceiver, partial information of a cell identifier (ID). The receiving is associated with a frequency offset between the first center frequency and a synchronization raster frequency. The UE also has one or more processors configured to perform cell detection based on the partial information of the cell ID.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a graph illustrating a frequency modulated continuous wave (FMCW) transmitted on a carrier across a bandwidth.

FIG. 5 is a block diagram illustrating FMCW signal mixing.

FIG. 6 is a graph illustrating FMCW processing.

FIG. 7 is a graph illustrating FMCW signals after FMCW mixing.

FIG. 8 illustrates graphs showing UE behaviors for FMCW receiver processing.

FIGS. 9 and 10 are graphs illustrating X-shaped FMCW waveforms, in accordance with various aspects of the present disclosure.

FIG. 11 is a block diagram illustrating X-shaped FMCW receiver designs, in accordance with various aspects of the present disclosure.

FIG. 12 is a diagram illustrating multiple cell sectors, in accordance with various aspects of the present disclosure.

FIG. 13 is a graph illustrating offset X-shaped FMCWs, in accordance with various aspects of the present disclosure.

FIG. 14 illustrates graphs showing offset X-shaped FMCW configurations, in accordance with various aspects of the present disclosure.

FIG. 15 illustrates graphs showing beat frequency domain responses, in accordance with various aspects of the present disclosure.

FIG. 16 illustrates tables showing multiple X-FMCW configurations mapping to a same secondary synchronization signal (SSS) and physical broadcast channel (PBCH), in accordance with various aspects of the present disclosure.

FIG. 17 is a flow diagram illustrating an example process performed, for example, by a user equipment (UE), in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with fifth generation (5G) and later wireless technologies, aspects of the present disclosure can be applied in other generation-based communications systems, such as and including third generation (3G) and/or fourth generation (4G) technologies.

A frequency modulated continuous wave (FMCW) is a continuous signal having a frequency that changes over time. For example, the frequency may increase (up-chirp) or decrease (down-chirp) with time. In some aspects, the increase or decrease may occur linearly. The frequency of the FMCW signal may be modulated or swept within a specific frequency range or bandwidth (e.g., ranging from a lower frequency to a higher frequency) in a continuous manner.

To enable network synchronization, a network may transmit a synchronization signal block (SSB) over a channel to a user equipment (UE), allowing the UE to perform measurements on the SSB, for example, to assess the channel conditions or identify a cell. In wireless systems, such as fifth generation (5G) new radio (NR) systems, various types of synchronization signals (SS) may be used to perform frequency (phase) and time compensation. In NR, two types of synchronization signals are used, referred to as a primary synchronization signal (PSS) and a secondary synchronization signal (SSS).

One potential waveform for an SS, such as a PSS, is a frequency modulated continuous wave (FMCW) waveform. An FMCW generally refers to a signal where the frequency increases linearly with time (referred to as an up-chirp) or decreases linearly with time (referred to as a down-chirp). In FMCW, a difference between the transmitted signal carrier frequency and the received signal carrier frequency is referred to as a beat frequency.

FMCW processing may allow channel estimation to be performed over an entire operating bandwidth, even if a UE does not support the full operating bandwidth, using narrowband baseband processing. For example, using FMCW as a downlink channel sounding reference signal, a UE with limited capability to support a relatively limited frequency range (e.g., 20 MHz, 100 MHz, 400 MHz, 1 GHz, etc.) may be able to perform wideband channel estimation for ultra-wide system bandwidth (e.g., 400 MHz to 8 GHz).

One potential issue with using an FMCW waveform is the potential for timing and frequency offset ambiguity. In other words, in some cases, a frequency offset (e.g., due to oscillator offset) and a timing offset may not be distinguishable at the detector output at the receiver. For example, the beat frequency of a first PSS candidate (PSS candidate 1) and of a second PSS candidate (PSS candidate 2) may appear to be the same within a searching window. This may make the UE unable to determine the frequency offset and time offset relative to the receiver-local FMCW, which makes the frequency/time synchronization coarse. As a result, precise frequency estimation and timing estimation may need to rely on another type of waveform, such as an SSS using a cyclic prefix orthogonal frequency division multiplexing (CP-OFDM) waveform.

An FMCW-based synchronization signal design may help remove the aforementioned ambiguity. An FMCW-based PSS may be formed using a first FMCW waveform with an associated frequency that increases (ramps up) linearly in time and a second FMCW waveform with an associated frequency that decreases (ramps down) linearly in time. Such a waveform will be referred to as an X-shaped FMCW or, more simply, an X-FMCW.

Aspects of the present disclosure propose a multiple PSS design by using X-FMCW waveforms with multiple frequency offsets. The frequency offsets can carry information bits. For example, the offsets may indicate partial information of a cell identifier (ID), such as the information provided by a PSS. The partial cell ID information may help the UE identify sectors of a cell site. For the receiver side, the FMCW receiver sweeps a different frequency hypothesis at the same time, with no additional complexity.

Particular aspects of the subject matter described in this disclosure can be implemented to realize one or more of the following potential advantages. In some examples, the described techniques, such as obtaining partial cell ID information from offset X-FMCWs may help distinguish sectors of a cell while the receiver sweeps multiple different frequency hypotheses simultaneously, without additional complexity.

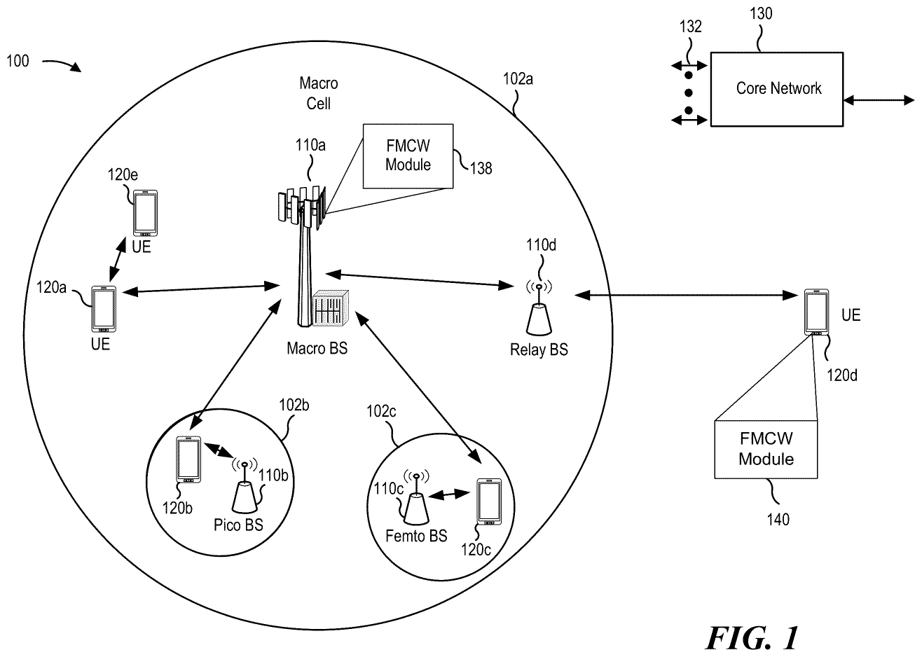

FIG. 1 is a diagram illustrating a wireless network 100 in which aspects of the present disclosure may be practiced. The wireless network 100 may be a 5G or new radio (NR) network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

In various aspects, a network entity or network node can be implemented as an aggregated base station, as a disaggregated base station, a component of a base station, an integrated access and backhaul (IAB) node, a relay node, a sidelink node, to name a few examples.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include an FMCW module 140. For brevity, only one UE 120d is shown as including the FMCW module 140. The FMCW module 140 may obtain a first frequency modulated continuous wave (FMCW) waveform having a first center frequency. The first FMCW has a first FMCW signal, and a second FMCW signal that intersects with the first FMCW signal. The FMCW module 140 may obtain partial information of a cell identifier (ID). The obtaining is associated with a frequency offset between the first center frequency and a synchronization raster frequency. The FMCW module 140 may perform cell detection based on the partial information of the cell ID.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

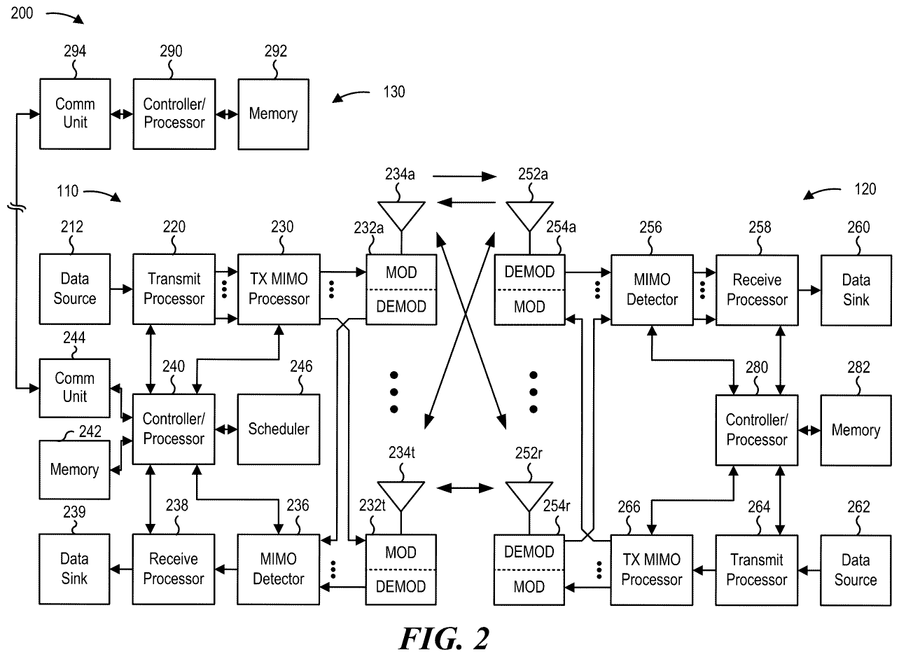

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (Tx) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a Tx MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

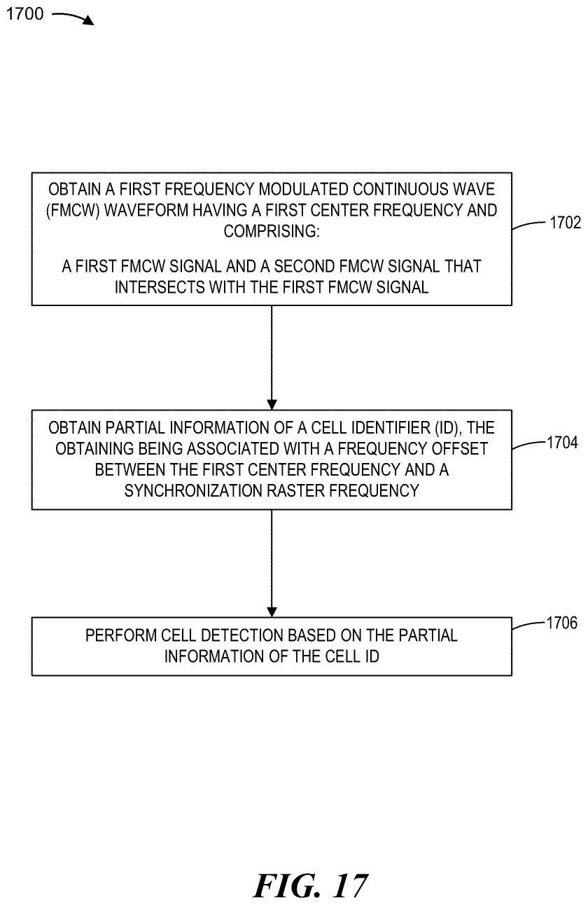

The controller/processor 240 of the base station 110, the controller/processor 280 of the UE 120, and/or any other component(s) of FIG. 2 may perform one or more techniques associated with X-FMCW processing, as described in more detail elsewhere. For example, the controller/processor 240 of the base station 110, the controller/processor 280 of the UE 120, and/or any other component(s) of FIG. 2 may perform or direct operations of, for example, the process of FIG. 17 and/or other processes as described. Memories 242 and 282 may store data and program codes for the base station 110 and UE 120, respectively. A scheduler 246 may schedule UEs for data transmission on the downlink and/or uplink.

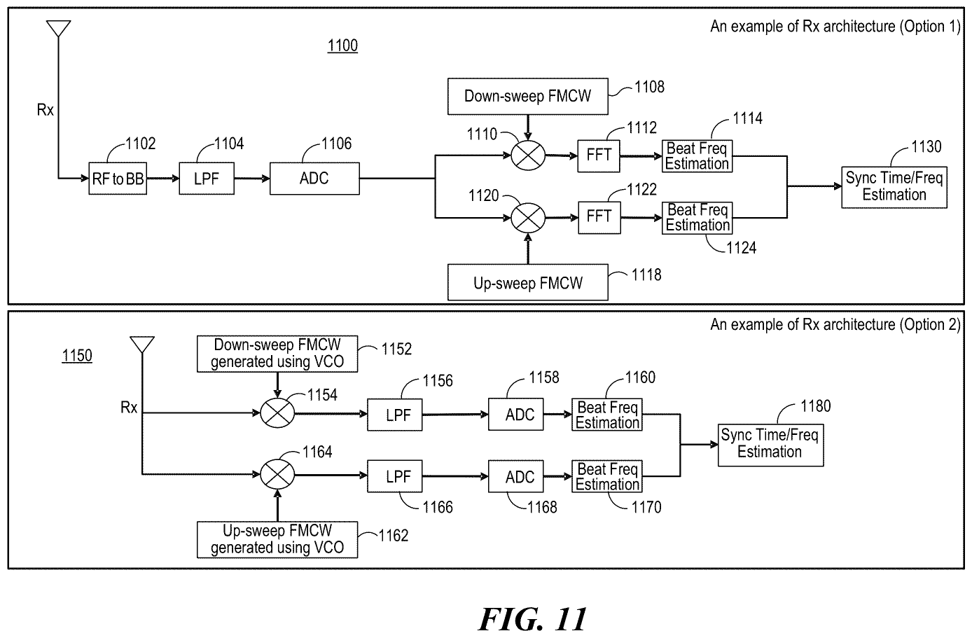

In some aspects, the UE 120 and/or base station 110 may include means for performing the method described with respect to FIG. 17, or any aspect related to the method. Means for obtaining, and means for performing may include one or more components of the UE 120 or base station 110 described in connection with FIG. 2, such as the antenna 234, 252, DEMOD/MOD 232, 254, MIMO detector 236, 256, receive processor 238, 258, TX MIMO processor 230, 266, transmit processor 220, 264, controller/processor 240, 280, memory 242, 282, and/or the receiver design 1100, 1150 described in connection with FIG. 11.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

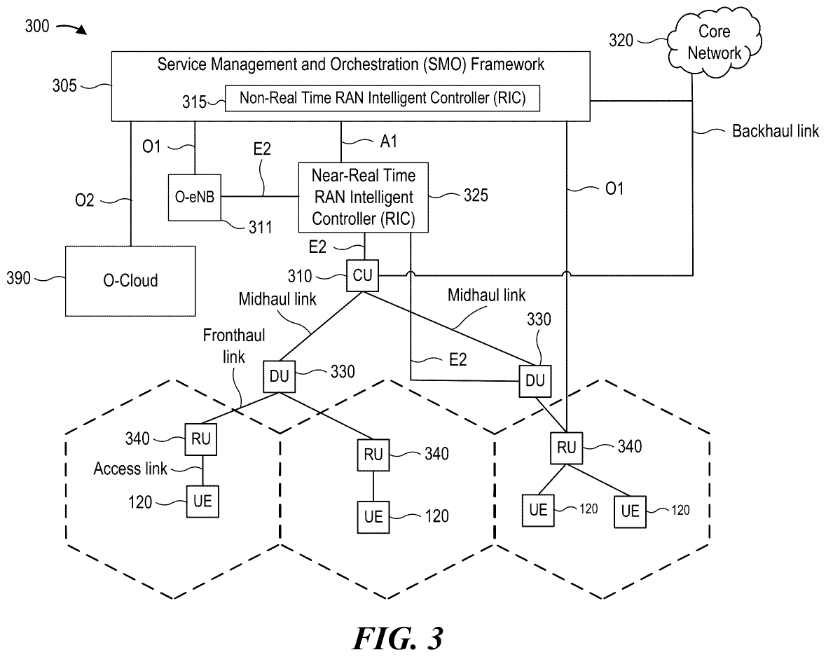

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

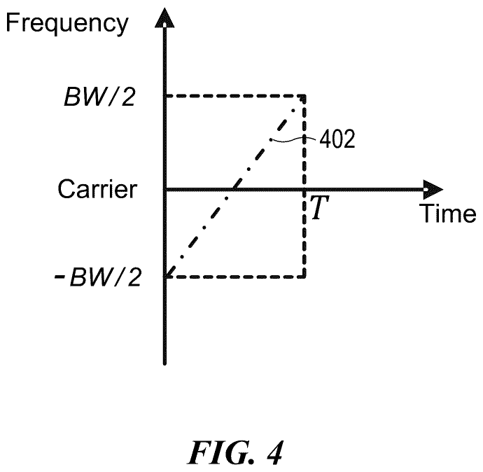

A frequency modulated continuous wave (FMCW) is a continuous signal having a frequency that changes over time. For example, the frequency may increase (up-chirp) or decrease (down-chirp) with time. In some aspects, the increase or decrease may occur linearly. The frequency of the FMCW signal may be modulated or swept within a specific frequency range or bandwidth (e.g., ranging from a lower frequency to a higher frequency) in a continuous manner. FIG. 4 is a graph illustrating an FMCW 402 transmitted on a carrier across a bandwidth (BW), starting at frequency −BW/2 and increasing to frequency BW/2 over a duration T.

Advantages of an FMCW include the ability for wideband (WB) sensing or channel estimating using narrowband baseband processing. Moreover, low-speed analog-to-digital converters (ADCs) may sample a beat signal, from several gigahertz (GHz) to less than 10 megahertz (MHz). Additionally, a low peak-to-average power ratio (PAPR) facilitates low complexity, full duplex sensing.

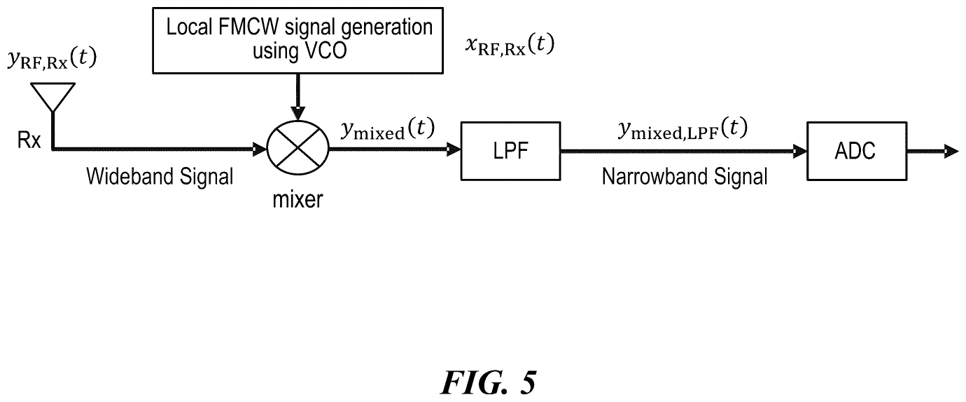

FIG. 5 is a block diagram illustrating FMCW signal mixing. In the example of FIG. 5, a received signal y_{RF,Rx}(t) passes from a receive antenna (Rx) to a mixer. In some cases, the received signal y_{RF,Rx}(t) is a wideband signal, but may also be a narrowband signal, in accordance with aspects of the present disclosure. The mixer mixes the received signal y_{RF,Rx}(t) at time t with a local FMCW signal x_{RF,Rx}(t) generated with a voltage controlled oscillator (VCO) to obtain a mixed signal, also referred to as a beat signal y_{mixed}(t). A low pass filter (LPF) filters the beat signal y_{mixed}(t) to obtain a filtered beat signal y_{mixed, LPF}(t). The filtered beat signal y_{mixed, LPF}(t) is a narrowband signal that is processed by an analog-to-digital convertor (ADC).

Synchronization signal block (SSB) processing is part of an initial access procedure for user equipment (UEs). To enable network synchronization, a network may transmit an SSB over a channel to a UE, allowing the UE to perform measurements on the SSB, for example, to assess the channel conditions or identify a cell sector. A network device, such as base station (e.g., gNB), may transmit a simple signal, such as light synchronization signal block (SSB), to announce the network device deployment to simplify a UE's initial cell search. When a UE detects the light SSB, the UE knows the cell is deployed and stays on a synchronization (sync) raster for a longer period of time to search for the actual SSB.

A frequency modulated continuous wave (FMCW)-based cell detection signal can be used as the light SSB. The UE scans multiple sync raster points at one time, with relatively low complexity. FMCW spreading helps to distinguish the light SSB from data during a scan, in a manner that is more robust than energy-based detection. Full search performance of FMCW-based PSS techniques matches PSS acquisition using m-sequences with a correlation-based detector.

An FMCW-based detector for a pre-SSB FMCW includes a single transmitter sweep with a long receiver sweep. The network transmits an FMCW-based primary synchronization signal (PSS) over a set of sync raster points (fᵢ). Unlike a conventional SSB, the transmitted FMCW does not include cell information. The UE is able to identify a time and a frequency of the signal with a mixer, and without synchronization.

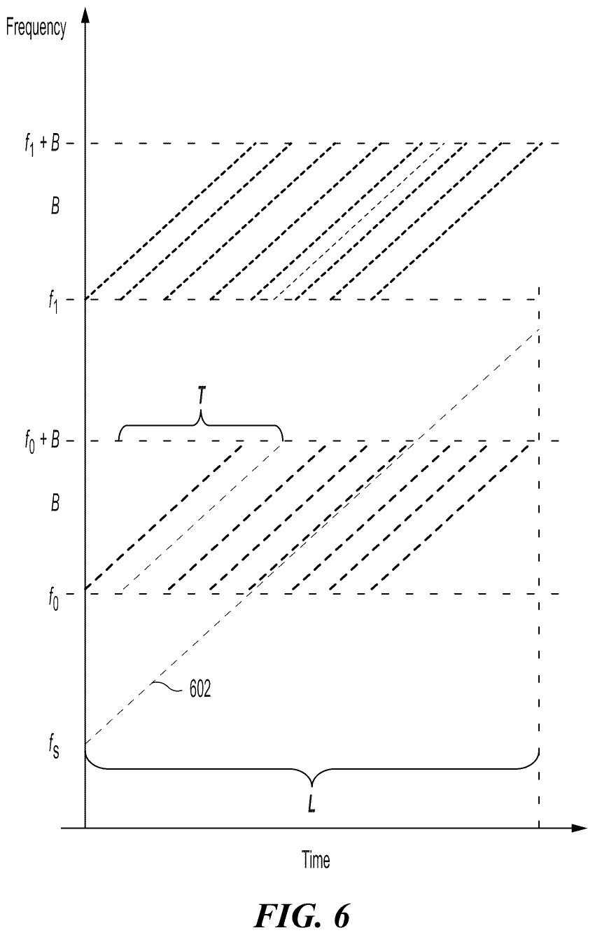

FIG. 6 is a graph illustrating FMCW processing. In the example of FIG. 6, an FMCW duration is shown as T and an FMCW bandwidth is shown as B. The duration may have a length of a single symbol. A transmitter sweep starts from frequency fᵢ and ends at frequency fᵢ+B, where fᵢ represents the set of raster points. For example, in FIG. 6, two FMCW instances are shown where a first instance starts at frequency f₀ and ends at frequency f₀+B, and a second instance starts at frequency f₁ and ends at frequency f₁+B. The starting time of the FMCW transmission is not known at the receiver for an initial search because the receiver has not yet acquired timing knowledge. There can be multiple sync raster points and the UE does not know which sync raster point is being used.

At the receiver, the UE uses an FMCW to mix the received signal. An FMCW detector sweep 602 starts from time 0 and frequency f_{S} with a slope of B/T. The sweep duration is L, where L>T. The first L−T part of the sweeping window is the effective range where the full FMCW sweep can be covered by the detector sweep 602.

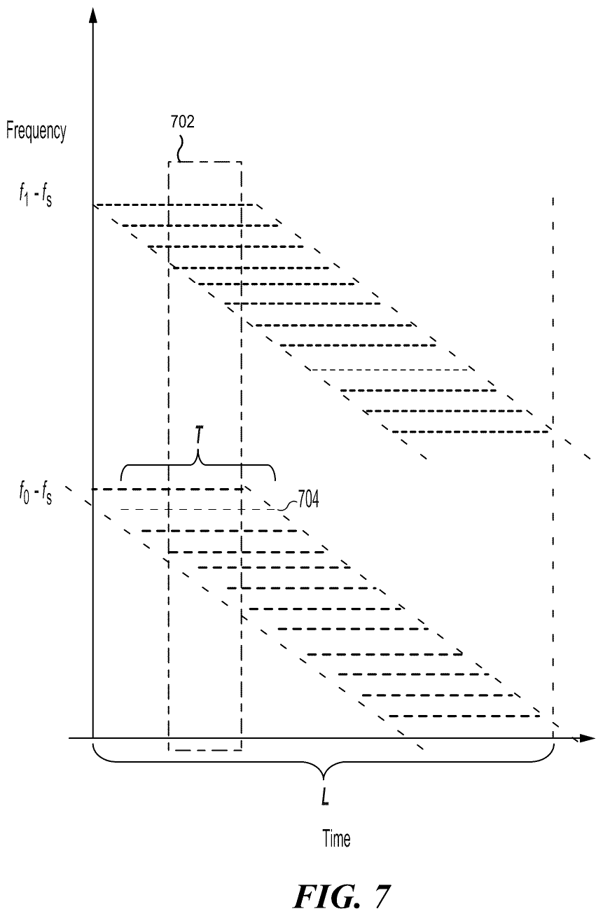

FIG. 7 is a graph illustrating FMCW signals after FMCW mixing. The FMCW may be a pre-SSB FMCW in this example. In FIG. 7, a UE processes a received signal in search window 702, window-by-window. As seen in FIG. 7, in a time or a frequency domain after the FMCW mixing at the receiver, the signature of an FMCW primary synchronization signal (PSS) is a horizontal line 704 with length T, starting at time t∈[0, L−T], and frequency

$${f}_{i} - {f}_{S} - \frac{tB}{T} .$$

To identify the pattern, back-to-back fast Fourier transforms (FFTs) of a duration

$$\frac{T}{2}$$

may be performed to identify peak locations in a frequency domain. The duration

$$\frac{T}{2}$$

is such that one of the FFT windows will capture the full pattern.

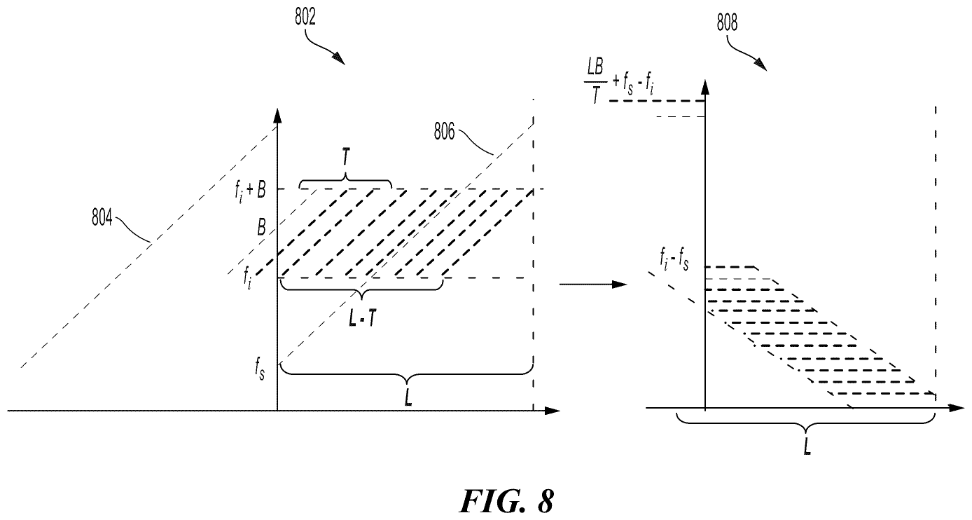

FIG. 8 illustrates graphs showing UE behaviors for FMCW receiver processing. The examples of FIG. 8 address edge cases. In a first option 802, a UE combines two back-to-back long receiver sweeps 804, 806 to enhance the detection capability for the case when the pre-SSBs FMCWs are partially covered by one long receiver sweep. In a second option 808, once the UE detects two well separated beat frequencies, the UE may adjust its local FMCW generation timing, for example, shifting by time T. Thus, the UE covers the whole pre-SSB FMCW in the next transmission cycle. In the second option 808 of FIG. 8,

$$\frac{L B}{T} + {f}_{s} - {f}_{i}$$

represents the beat signal frequency measured from the previous back-to-back search.

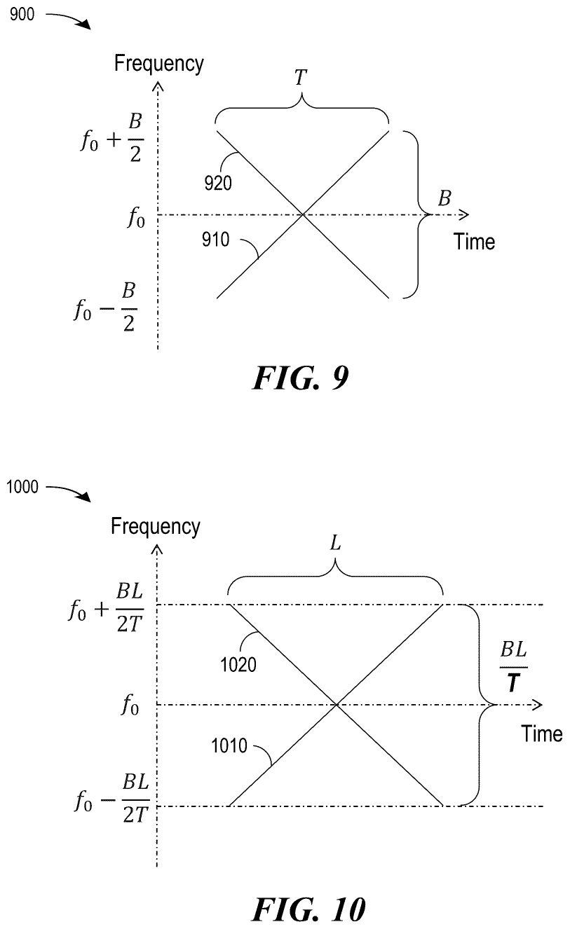

An X-shaped FMCW-based synchronization signal design may help resolve or clarify time/frequency ambiguities with FMCW waveforms. FIGS. 9 and 10 are graphs 900 and 1000, respectively, illustrating X-shaped FMCW waveforms, in accordance with various aspects of the present disclosure. As illustrated in the graph 900 of FIG. 9, and as will be described in greater detail below, an X-shaped FMCW-based PSS may be formed using a first FMCW waveform 910 with an associated frequency that increases (ramps up from

$${f}_{0} - \frac{B}{2} to {f}_{0} + \frac{B}{2} )$$

linearly in time (over a period T) and a second FMCW waveform 920 with an associated frequency that decreases (ramps down from

$${f}_{0} + \frac{B}{2} to {f}_{0} - \frac{B}{2} )$$

linearly in time (over T). Thus, the first FMCW waveform 910 has a slope of B/T, while the second FMCW waveform 920 has a slope of −B/T.

As illustrated, by using the same up-sweep ramp and down-sweep ramp, the first and second FMCW waveforms 910 and 920 form an X shape. A center of the X shape may be defined as fᵢ, and may align with a synchronization raster point for a corresponding synchronization signal (e.g., PSS) formed thereby. In some cases, an orthogonal frequency division multiplexing (OFDM) architecture may generate the FMCW waveform(s) for the PSS.

While the transmitted FMCW signals (for a particular PSS candidate) may be swept over a frequency of band B for a time duration of T, the receiver does not know the timing and frequency information. Therefore, the receiver may search for PSS candidates over a larger resource grid. For example, as illustrated in the graph 1000 of FIG. 10, a receiver may search over a larger frequency band of B*L/T

$$( from {f}_{0} - \frac{B L}{2 T} to {f}_{0} + \frac{B L}{2 T} )$$

and a time duration of L (where L>T). The receiver may search over two paths 1010 and 1020, with one ramping up and one ramping down, but both with a slope of B/T. In some cases, the parameters may be relaxed, for example, such that the parallel paths may not (both) be centered at f₀. A receiver (e.g., a UE) may be able to search multiple sync rasters at the same time. The waveforms also do not necessarily need to be symmetric.

Various options for circuit architectures for the X-shaped FMCW-based PSS detector will now be discussed. FIG. 11 is a block diagram illustrating X-shaped FMCW receiver designs, in accordance with various aspects of the present disclosure. As illustrated in a first design 1100, a received signal at a receive antenna (Rx) is converted from radio frequency (RF) to baseband (BB) at an RF to BB block 1102. After low pass filtering by a low pass filter (LPF) 1104, the filtered analog signal is converted into digital format by an analog-to-digital converter (ADC) 1106. The digital signal is split and mixed with a down-sweep FMCW generated by a first voltage controlled oscillator (VCO) 1108 at a first mixer 1110. The other portion of the digital signal is mixed with an up-sweep FMCW generated by a second voltage controlled oscillator (VCO) 1118 at a second mixer 1120. After processing by separate fast Fourier transformers (FFTs) 1112, 1122, and separate frequency estimation blocks 1114, 1124, a frequency and time offset estimation block 1130 estimates the time and frequency.

According to a second design 1150 for a receiver, a first VCO path includes a first VCO 1152 to generate a down-sweep FMCW to combine with the received signal at a first mixer 1154. A second VCO path includes a second VCO 1162 to generate an up-sweep FMCW to combine with the received signal at a second mixer 1164. Each VCO path generates a mixer output (after low pass filters (LPFs) 1156, 1166) to be processed by separate analog-to-digital converters (ADCs) 1158, 1168 and separate frequency estimation blocks 1160, 1170, followed by a frequency and time offset estimation block 1180.

Depending on the particular implementation, the X-shaped FMCW signal(s) may be transmitted in different numerologies (e.g., with each numerology defining a subcarrier spacing/symbol time, cyclic prefix (CP) size) and different frequency ranges (FRs). As a result, the choice of values for B and T may lead to different FMCW slopes (B/T).

In some cases, in order to allow the receiver (e.g., UE) to use one X-shaped FMCW receiver for multiple synchronization raster PSS detection and synchronization, the slope of the corresponding X-shaped FMCW waveforms in multiple synchronization rasters may be kept the same. Otherwise, the UE may use different local X-shaped FMCW slopes to perform the detection.

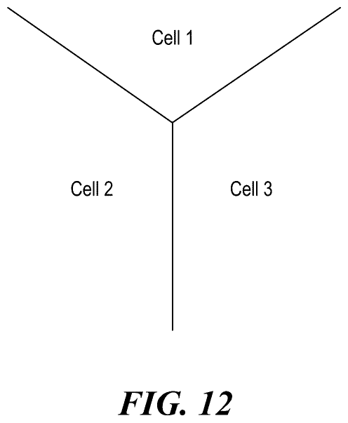

FIG. 12 is a diagram illustrating multiple cell sectors, in accordance with various aspects of the present disclosure. A cell site may have multiple sectors, for example three cells, as seen in the example of FIG. 12. The UE should be able to distinguish the sectors. Currently, the PSS has three candidates for distinguishing the three sectors in a cell site. Unfortunately, the three candidates require more PSS search and correlation, such that the complexity is not implementation friendly.

The FMCW waveform may be used for information other than a pre-SSB. An X-shaped FMCW (X-FMCW) waveform may be used to carry partial cell identifier (ID) information, such as a PSS. However, it is difficult for the X-FMCW to carry additional information. For example, carrying information in slopes of the waveform is not searcher friendly because the receiver needs to try to correlate different slopes, increasing complexity. Carrying additional information in a phase difference between up and down chirps may be possible for a single transmit (Tx) antenna case, where the phase difference between the two chirps is under control. For the more than two Tx antenna case, issues such as cross polarization may prevent use of the phase difference. For example, when transmitting through separate Tx chains, the phase difference may not be easy to control.

Aspects of the present disclosure propose a multiple PSS design by using X-FMCW waveforms with multiple frequency offsets. The frequency offsets can carry information bits. For example, the offsets may indicate partial information of a cell identifier (ID), such as the information provided by a PSS. The partial cell ID information may help the UE identify sectors of a cell site. For the receiver side, the FMCW receiver sweeps a different frequency hypothesis at the same time, with no additional complexity.

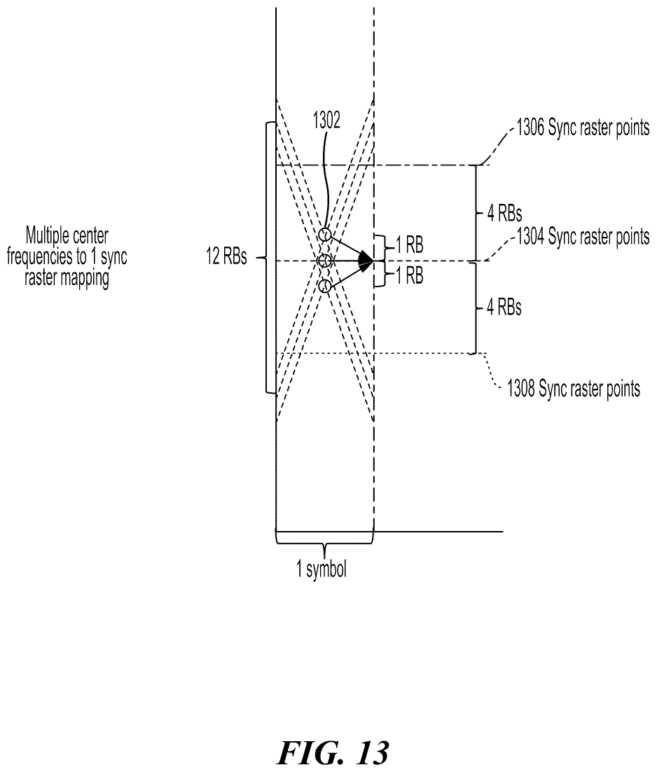

FIG. 13 is a graph illustrating offset X-shaped FMCWs, in accordance with various aspects of the present disclosure. In the example of FIG. 13, a first set of frequency raster points 1304 is spaced four resource blocks (RBs) apart from second and third sets of raster points 1306, 1308. Multiple center frequencies 1302 (only one center frequency labeled) map to a same synchronization (sync) raster (e.g., first set of raster points 1304 in the example of FIG. 13). The different frequency offsets between different center points 1302 of the different X-FMCWs map to different PSS sequences. The one RB frequency offset between center points 1302 shown in FIG. 13 is not limiting and may be generalized to a different value, as described below in more detail. Moreover, the three different frequency offsets shown in FIG. 13 are non-limiting, as other frequency offsets are also possible.

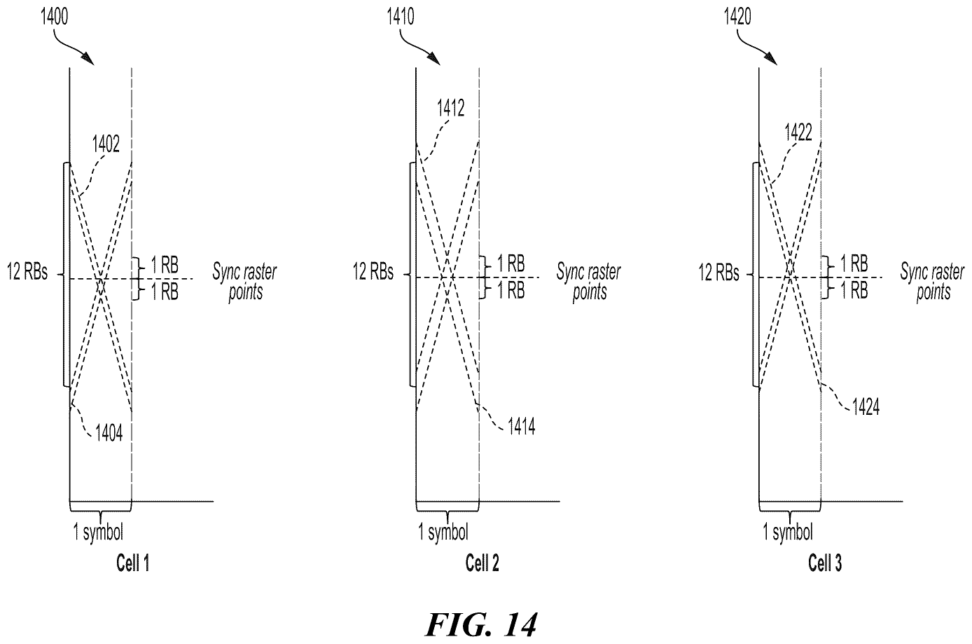

FIG. 14 illustrates graphs showing offset X-shaped FMCW configurations, in accordance with various aspects of the present disclosure. In the example of FIG. 14, a first configuration 1400 corresponds to a first cell (cell 1). In the first configuration 1400, a first center point offset is a one RB frequency gap between two X-FMCW waveforms 1402, 1404. A first center point of a first X-FMCW waveform 1402 coincides with the sync raster points. A second center point of a second X-FMCW waveform 1404 is one RB below the sync raster points. The frequency gap and the location relationship to the nominal sync raster points may indicate partial cell ID information, e.g., cell 1 in the first configuration 1400. The location of each center point may be also referred to as a sub-sync raster.

In the example of FIG. 14, a second configuration 1410 corresponds to a second cell (cell 2). In the second configuration 1410, a second offset is a two RB frequency gap between the center points of two X-FMCW waveforms 1412, 1414. A first center point of a first X-FMCW waveform 1412 is one RB above the sync raster points. A second center point of a second X-FMCW waveform 1414 is one RB below the sync raster points. The frequency gap and the location relationship to the nominal sync raster points may indicate partial cell ID information, e.g., cell 2 in the second configuration 1410.

In the example of FIG. 14, a third configuration 1420 corresponds to a third cell (cell 3). In the third configuration 1420, a third offset is a one RB frequency gap between two X-FMCW waveforms 1422, 1424. A first center point of a first X-FMCW waveform 1422 is one RB above the sync raster points. A second center point of a second X-FMCW waveform 1414 coincides with the sync raster points. Thus, the frequency gap and the location relationship to the nominal sync raster points may indicate partial cell ID information, e.g., cell 3 in the third configuration 1420.

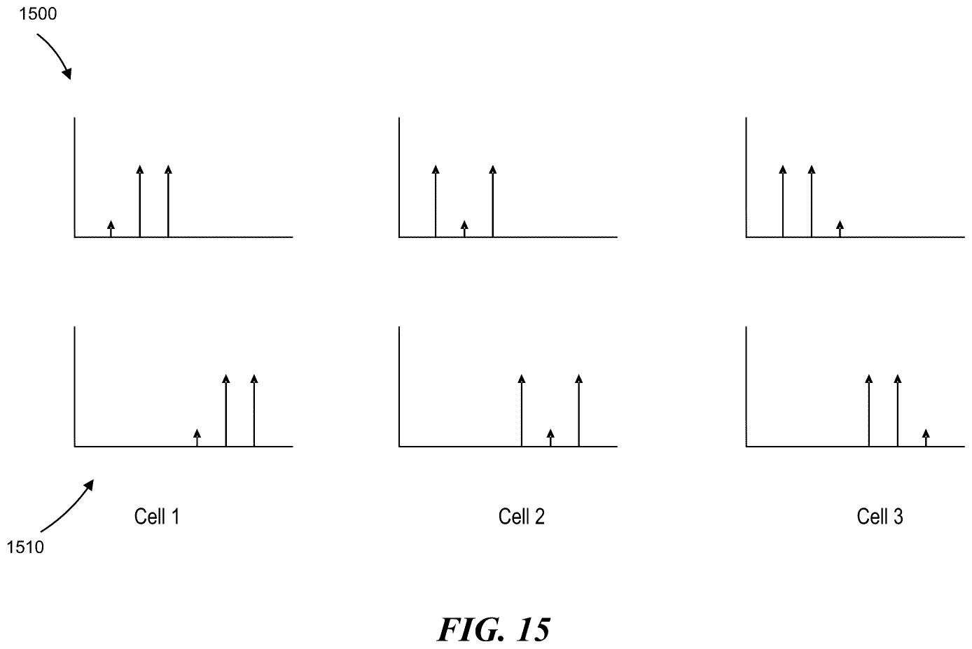

FIG. 15 illustrates graphs showing beat frequency domain responses, in accordance with various aspects of the present disclosure. In the example of FIG. 15, an X-FMCW receiver sees beat frequency domain responses for different cells based on the configurations 1400, 1410, and 1420 (corresponding to cell 1, cell 2, and cell 3) shown in FIG. 14. The various up-chirp beat frequency responses 1500 and down-chirp beat frequency responses 1510 indicate cells 1, 2, and 3.

Conventionally, the full cell ID information can be obtained from the combination of the PSS, the secondary synchronization signal (SSS), physical broadcast channel (PBCH), and/or control resource set zero (CORESET 0). According to aspects of the present disclosure, multiple X-FMCW offsets and location displacement configurations map to a same SSS, PBCH, and/or CORESET 0. Thus, the X-FMCW configuration provides the full information of a cell identity. Accordingly, the UE does not need to perform a blind search for the SSS and PBCH.

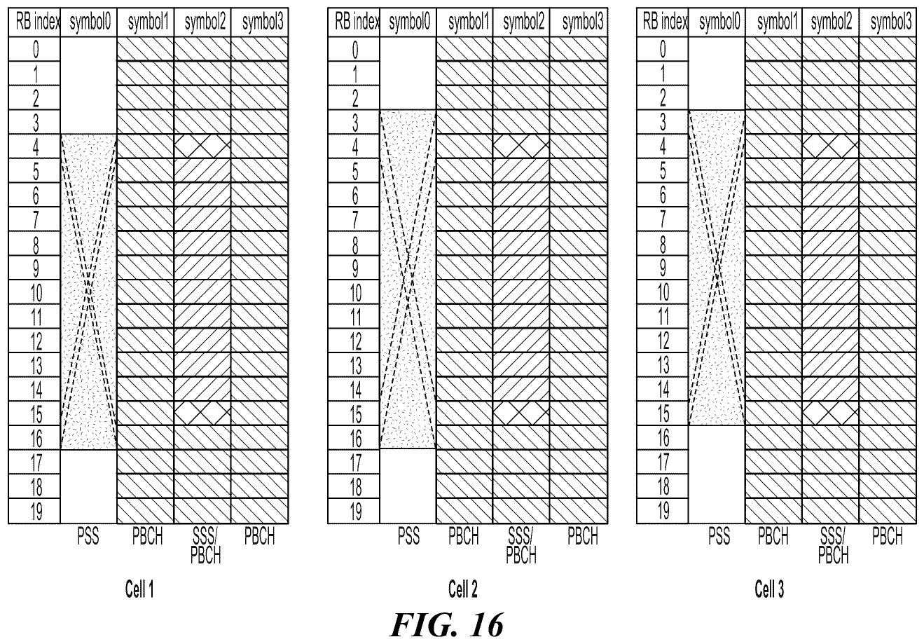

FIG. 16 illustrates tables showing multiple X-FMCW configurations mapping to a same secondary synchronization signal (SSS) and physical broadcast channel (PBCH), in accordance with various aspects of the present disclosure. In the example of FIG. 16, a cell 1 X-FMCW configuration, a cell 2 X-FMCW configuration, and a cell 3 X-FMCW configuration all map to the same SSS and PBCH locations in symbol two. More specifically, RB indexes 4-15 correspond to SSS and RB indexes 0-3 and 16-18 correspond to PBCH. In contrast to SSS and PBCH, the frequency resource allocation for PSS differs for each of the three cells. For example, RB indexes 4-16 correspond to PSS for cell 1, RB indexes 3-16 correspond to PSS for cell 2, and RB indexes 3-15 correspond to PSS for cell 3.

According to further aspects of the present disclosure, the center frequency offset should be distinguishable under carrier frequency offset (CFO) and Doppler frequency ranges in any design being considered. For example, in a high speed train scenario, where the Doppler effect is higher, the frequency offset should be set accordingly. In other words, the offset should be larger than the maximum CFO and Doppler frequency for the particular design being considered to avoid any ambiguity. A few resource blocks (RBs) or a few resource elements (REs) should be enough of a frequency offset, in most cases.

In some aspects, the frequency offset is fixed within each range of frequency. For example, in a first range (e.g., a low band): 0-3000 MHz, the frequency offset is fixed at a first value. In a second range (e.g., a mid-band): 3000 MHz-24250 MHz, the frequency offset is fixed at a second value. In a third range (e.g., a high band): 24250-100000 GHz, the frequency offset is fixed at a third value.

In other aspects, the frequency offset increases (or does not decrease) with the increase of a center carrier frequency. The increase (or lack of decrease) is desirable because the maximum CFO and maximum Doppler frequency increase with the increase of the center carrier frequency. For example, the center carrier frequency f1 may be less than the center frequency f2, which may be less than the center frequency f3, which may be less than the center frequency f4, which may be less than the center frequency f5, which may be less than the center frequency f6. In other words, f1<f2<f3<f4<f5<f6. The frequency offset of1 may be less than the frequency offset of2, which may be equal to the frequency offset of3, which is less than the frequency offset of4, which may be equal to the frequency offset of5, which is less than the frequency offset of6. In other words, of1<of2=of3<of4=of5<of6.

FIG. 17 is a flow diagram illustrating an example process 1700 performed, for example, by a user equipment (UE), in accordance with various aspects of the present disclosure. The example process 1700 is an example of obtaining cell identifier information from offset X-shaped frequency modulated continuous waves. The operations of the process 1700 may be implemented by a UE 120.

At block 1702, the user equipment (UE) obtains a first frequency modulated continuous wave (FMCW) waveform having a first center frequency. The first FMCW has a first FMCW signal, and a second FMCW signal that intersects with the first FMCW signal. For example, the UE (e.g., using the antenna 252, DEMOD/MOD 254, MIMO detector 256, receive processor 258, controller/processor 280, memory 282, and/or the like) may obtain the first FMCW waveform. In some aspects, the first FMCW signal is associated with a frequency that increases in time for a duration according to a first slope, and the second FMCW signal is associated with a frequency that decreases in time for the duration according to a second slope that is a negative of the first slope.

At block 1704, the user equipment (UE) obtains partial information of a cell identifier (ID). The obtaining is associated with a frequency offset between the first center frequency and a synchronization raster frequency. For example, the UE (e.g., using the antenna 252, DEMOD/MOD 254, MIMO detector 256, receive processor 258, controller/processor 280, memory 282, and/or the like) may obtain the partial information of the cell ID. In some aspects, the partial information of the cell ID comprises a primary synchronization signal (PSS) ID. In some aspects, the frequency offset comprises one resource block (RB). The frequency offset may be greater than or equal to a maximum carrier frequency offset plus a maximum Doppler frequency range for a scenario. The frequency offset may be fixed within a carrier frequency range of a synchronization raster. The frequency offset may increase while a center carrier frequency of a synchronization raster is increasing.

At block 1706, the user equipment (UE) performs cell detection based on the partial information of the cell ID. For example, the UE (e.g., using the antenna 252, DEMOD/MOD 254, MIMO detector 256, receive processor 258, TX MIMO processor 266, transmit processor 264, controller/processor 280, memory 282, and/or the like) may perform cell detection.

### EXAMPLE ASPECTS

Aspect 1: A method for wireless communication at a wireless node, comprising: obtaining a first frequency modulated continuous wave (FMCW) waveform having a first center frequency and comprising: a first FMCW signal, and a second FMCW signal that intersects with the first FMCW signal; and obtaining partial information of a cell identifier (ID), the obtaining being associated with a frequency offset between the first center frequency and a synchronization raster frequency; and performing cell detection based on the partial information of the cell ID.

Aspect 2: The method of Aspect 1, further comprising: obtaining a second center frequency of a second X-FMCW waveform, the second center frequency being offset in frequency from the first center frequency, the first center frequency and the second center frequency mapping to a same synchronization raster; and obtaining the partial information of the cell ID from the offset in frequency between the first center frequency and the second center frequency, from a first relationship between the synchronization raster and the first center frequency, and from a second relationship between the synchronization raster and the second center frequency.

Aspect 3: The method of Aspect 2, wherein the partial information of the cell ID comprises a primary synchronization signal (PSS) ID.

Aspect 4: The method of Aspect 3, wherein the PSS ID corresponds to a first cell sector.

Aspect 5: The method of Aspect 4, wherein a secondary synchronization signal (SSS) resource allocation and a physical broadcast channel (PBCH) resource allocation correspond to the first cell sector and also to a second cell sector.

Aspect 6: The method of any of the Aspects 1-5, wherein the frequency offset comprises one resource block (RB).

Aspect 7: The method of any of the Aspects 1-6, wherein the frequency offset is greater than or equal to a maximum carrier frequency offset plus a maximum Doppler frequency range for a scenario.

Aspect 8: The method of any of the Aspects 1-7, wherein the frequency offset is fixed within a carrier frequency range of a synchronization raster.

Aspect 9: The method of any of the Aspects 1-7, wherein the frequency offset increases while a center carrier frequency of a synchronization raster is increasing.

Aspect 10: The method of any of the aspects 1-9, wherein the first FMCW signal is associated with a frequency that increases in time for a duration according to a first slope, and the second FMCW signal is associated with a frequency that decreases in time for the duration according to a second slope that is a negative of the first slope.

Aspect 11: An apparatus, comprising: a memory comprising executable instructions; and one or more processors configured to execute the executable instructions and cause the apparatus to perform a method in accordance with any one of Aspects 1-10.

Aspect 12: An apparatus, comprising means for performing a method in accordance with any one of Aspects 1-10.

Aspect 13: A non-transitory computer-readable medium comprising executable instructions that, when executed by one or more processors of an apparatus, cause the apparatus to perform a method in accordance with any one of Aspects 1-10.

Aspect 14: A computer program product embodied on a computer-readable storage medium comprising code for performing a method in accordance with any one of Aspects 1-10.

Aspect 15: A wireless node (e.g., a user equipment (UE)), comprising: at least one transceiver; at least one memory comprising instructions; and at least one processor configured to execute the instructions to cause the wireless node to: receive, via the at least one transceiver, a first frequency modulated continuous wave (FMCW) waveform having a first center frequency and comprising: a first FMCW signal, and a second FMCW signal that intersects with the first FMCW signal; receive, via the at least one transceiver, partial information of a cell identifier (ID), the receiving being associated with a frequency offset between the first center frequency and a synchronization raster frequency; and perform cell detection based on the partial information of the cell ID.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for wireless communication, comprising:
at least one processor;
at least one memory coupled with the at least one processor; and
instructions stored in the at least one memory and operable, when executed by the at least one processor, to cause the apparatus to:
obtain a first frequency modulated continuous wave (FMCW) waveform having a first center frequency and comprising:
a first FMCW signal,
and a second FMCW signal that intersects with the first FMCW signal;
obtain partial information of a cell identifier (ID), the obtaining being associated with a frequency offset between the first center frequency and a synchronization raster frequency; and
perform cell detection based on the partial information of the cell ID.

2. The apparatus of claim 1, wherein the at least one processor is further configured to:
obtain a second center frequency of a second X-FMCW waveform, the second center frequency being offset in frequency from the first center frequency, the first center frequency and the second center frequency mapping to a synchronization raster; and
obtain the partial information of the cell ID from the offset in frequency between the first center frequency and the second center frequency, from a first relationship between the synchronization raster and the first center frequency, and from a second relationship between the synchronization raster and the second center frequency.

3. The apparatus of claim 2, wherein the partial information of the cell ID comprises a primary synchronization signal (PSS) ID.

4. The apparatus of claim 3, wherein the PSS ID corresponds to a first cell sector.

5. The apparatus of claim 4, wherein a secondary synchronization signal (SSS) resource allocation and a physical broadcast channel (PBCH) resource allocation correspond to the first cell sector and also to a second cell sector.

6. The apparatus of claim 1, wherein the frequency offset comprises one resource block (RB).

7. The apparatus of claim 1, wherein the frequency offset is greater than or equal to a maximum carrier frequency offset plus a maximum Doppler frequency range for a scenario.

8. The apparatus of claim 1, wherein the frequency offset is fixed within a carrier frequency range of a synchronization raster.

9. The apparatus of claim 1, wherein the frequency offset increases while a center carrier frequency of a synchronization raster is increasing.

10. The apparatus of claim 1, wherein the first FMCW signal is associated with a frequency that increases in time for a duration according to a first slope, and the second FMCW signal is associated with a frequency that decreases in time for the duration according to a second slope that is a negative of the first slope.

11. A method for wireless communication at a wireless node, comprising:
obtaining a first frequency modulated continuous wave (FMCW) waveform having a first center frequency and comprising:
a first FMCW signal, and a second FMCW signal that intersects with the first FMCW signal;
obtaining partial information of a cell identifier (ID), the obtaining being associated with a frequency offset between the first center frequency and a synchronization raster frequency; and
performing cell detection based on the partial information of the cell ID.

12. The method of claim 11, further comprising:
obtaining a second center frequency of a second X-FMCW waveform, the second center frequency being offset in frequency from the first center frequency, the first center frequency and the second center frequency mapping to a same synchronization raster; and
obtaining the partial information of the cell ID from the offset in frequency between the first center frequency and the second center frequency, from a first relationship between the synchronization raster and the first center frequency, and from a second relationship between the synchronization raster and the second center frequency.

13. The method of claim 12, wherein the partial information of the cell ID comprises a primary synchronization signal (PSS) ID.

14. The method of claim 13, wherein the PSS ID corresponds to a first cell sector.

15. The method of claim 14, wherein a secondary synchronization signal (SSS) resource allocation and a physical broadcast channel (PBCH) resource allocation correspond to the first cell sector and also to a second cell sector.

16. The method of claim 11, wherein the frequency offset comprises one resource block (RB).

17. The method of claim 11, wherein the frequency offset is greater than or equal to a maximum carrier frequency offset plus a maximum Doppler frequency range for a scenario.

18. The method of claim 11, wherein the frequency offset is fixed within a carrier frequency range of a synchronization raster.

19. The method of claim 11, wherein the frequency offset increases while a center carrier frequency of a synchronization raster is increasing.

20. A user equipment (UE), comprising:
at least one transceiver;
at least one memory comprising instructions; and
at least one processor configured to execute the instructions to cause the UE to:
receive, via the at least one transceiver, a first frequency modulated continuous wave (FMCW) waveform having a first center frequency and comprising:
a first FMCW signal, and a second FMCW signal that intersects with the first FMCW signal;
receive, via the at least one transceiver, partial information of a cell identifier (ID), the receiving being associated with a frequency offset between the first center frequency and a synchronization raster frequency; and
perform cell detection based on the partial information of the cell ID.
